(19) United States
(12) Patent Application Publication
(10) Pub. No.: US 2015/0270925 A1
(43) Pub. Date: Sep. 24, 2015

(54) INTERFERENCE ESTIMATION FOR SELECTION OF MODULATION AND CODING SCHEMES

(71) Applicant: QUALCOMM Incorporated, San Diego, CA (US)

(72) Inventors: Dexu Lin, San Diego, CA (US); Jelena Damnjanovic, Del Mar, CA (US); Anastasios Stamoulis, San Diego, CA (US); Yongbin Wei, San Diego, CA (US); Kiran K. Somasundaram, San Diego, CA (US); Shi Cong Yang, San Jose, CA (US)

(73) Assignee: QUALCOMM Incorporated, San Diego, CA (US)

(21) Appl. No.: 14/218,198

(22) Filed: Mar. 18, 2014

(51) Int. Cl. H04L 1/00; H04W 72/04; H04W 72/08

(52) U.S. Cl. CPC H04L 1/0015; H04W 72/082; H04W 72/0453

(57) ABSTRACT

A modulation and coding scheme (MCS) is selected for one or more transmissions from a first wireless device to a second wireless device, based at least in part on interference at the second wireless device during a time period. The interference excludes wireless signals present at the second wireless device at first times during the time period when the first wireless device is transmitting and at second times during the time period when the first wireless device detects transmissions.

### TECHNICAL FIELD

The present embodiments relate generally to wireless communications, and specifically to selection of transmission parameters such as modulation and coding schemes.

### BACKGROUND OF RELATED ART

Co-channel interference occurs when multiple wireless devices transmit on the same frequency band. Improper estimation of the interference may result in selection of a modulation and coding scheme that unduly degrades network performance. Also, packet loss due to high interference power, which is also called collision, should be treated differently than packet loss due to poor channel conditions (e.g., channel fade).

### SUMMARY

In some embodiments, a method of facilitating wireless communication includes selecting a modulation and coding scheme (MCS) for one or more transmissions from the first wireless device to the second wireless device. Selection of the MCS is performed at either the first wireless device or the second wireless device. The MCS is selected based at least in part on interference at the second wireless device during a time period. The interference excludes wireless signals present at the second wireless device at first times during the time period when the first wireless device is transmitting and at second times during the time period when the first wireless device detects transmissions.

In some embodiments, a wireless device includes one or more antennas and a wireless modem to transmit and receive transmissions through the one or more antennas. The wireless device also includes one or more processors and memory storing one or more programs configured for execution by the one or more processors. The one or more programs include instructions to select an MCS for one or more transmissions from a first wireless device to a second wireless device, based at least in part on interference at the second wireless device during a time period. The interference excludes wireless signals present at the second wireless device at first times during the time period when the first wireless device is transmitting and at second times during the time period when the first wireless device detects transmissions.

In some embodiments, a non-transitory computer-readable storage medium stores one or more programs configured for execution by one or more processors. The one or more programs include instructions to select an MCS for one or more transmissions from a first wireless device to a second wireless device, based at least in part on interference at the second wireless device during a time period. The interference excludes wireless signals present at the second wireless device at first times during the time period when the first wireless device is transmitting and at second times during the time period when the first wireless device detects transmissions.

### BRIEF DESCRIPTION OF THE DRAWINGS

The present embodiments are illustrated by way of example and are not intended to be limited by the figures of the accompanying drawings.

FIG. 1 is a block diagram of a wireless network in accordance with some embodiments.

FIG. 2 is a graph showing wireless channel power as measured at a wireless device in accordance with some embodiments.

FIG. 3 is a graph of a busy-idle signal as generated at a wireless device in accordance with some embodiments.

FIG. 4 is a graph of interference that may be used in selecting a modulation and coding scheme in accordance with some embodiments.

FIG. 5 shows a Markov chain used to determine an average transmission delay resulting from backoff in accordance with some embodiments.

FIG. 6 is a flowchart showing a method of performing MCS adaptation in accordance with some embodiments.

FIG. 7A is a flowchart showing a method of determining whether packet loss results from packet collision in accordance with some embodiments.

FIG. 7B is a flowchart showing a method of performing transmission parameter adaptation based at least in part on whether or not packet loss resulted from packet collision in accordance with some embodiments.

FIG. 8 is a flowchart showing a method in which MCS adaptation is performed using one of two available MCS adaptation algorithms in accordance with some embodiments.

FIG. 9 is a block diagram of a wireless device in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

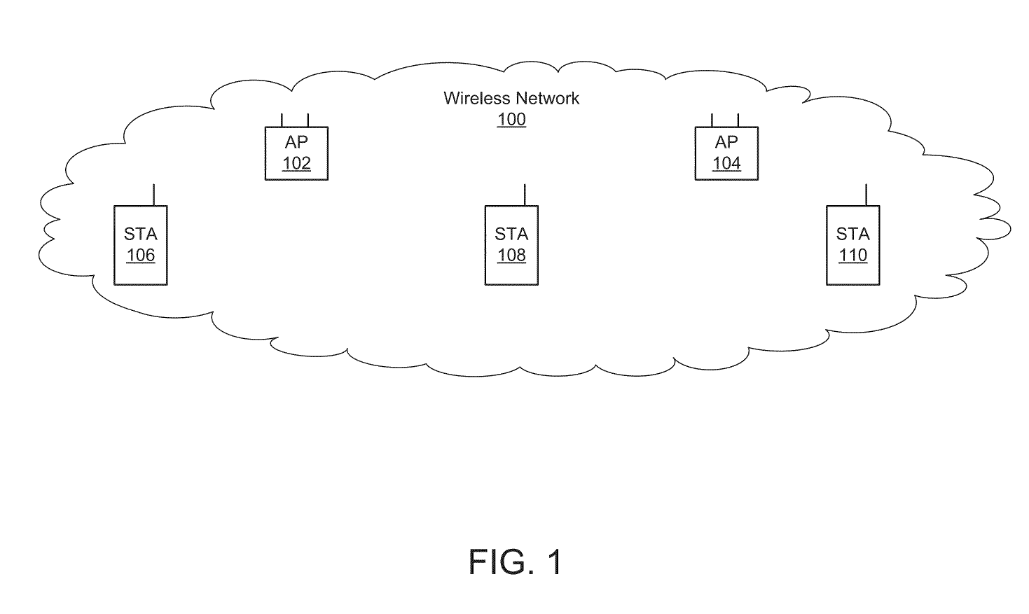

FIG. 1 is a block diagram of a wireless network 100 in accordance with some embodiments. The wireless network 100 includes access points 102 and 104 and stations 106, 108, and 110. While FIG. 1 shows two access points 102 and 104 and three stations 106, 108, and 110, in general the number of access points and stations in the wireless network 100 may vary. A station 106, 108, or 110 may communicate with an access point 102 or 104 if it is within range of the access point 102 or 104. In the example of FIG. 1, the station 106 is within range of the access point 102, the station 108 is within range of both access points 102 and 104, and the station 110 is within range of the access point 104. Transmissions from an access point 102 or 104 to a station 106, 108, or 110 are referred to as downlink transmissions. Transmissions from a station 106, 108, or 110 to an access point 102 or 104 are referred to as uplink transmissions. In some embodiments, the access points 102 and 104 and/or stations 106, 108, and 110 are wireless devices with multiple antennas. For example, the access points 102 and 104 and/or stations 106, 108, and 110 may be multiple-input-multiple-output (MIMO) wireless devices. Alternatively, the access points 102 and 104 and/or stations 106, 108, and 110 are single-antenna devices.

The access points 102 and 104 may provide the stations 106, 108, and 110 with access to one or more networks beyond the wireless network 100, and thus serves as gateways to one or more wider networks. For example, the access points 102 and 104 may provide the stations 106, 108, and 110 with access to a wide-area network (WAN), metropolitan-area network (MAN), campus network, and/or the Internet.

In some embodiments, the wireless network 100 is a wireless local area network (WLAN). For example, the wireless network 100 may be a WiFi network that operates in accordance with one or more protocols in the IEEE 802.11 family of protocols. In other embodiments, the wireless network 100 is a cellular network that operates in accordance with a cellular protocol. For example, the wireless network 100 may be a Long-Term Evolution (LTE) network. In other embodiments, the wireless network 100 may be a LTE-Advanced network over unlicensed spectrum (LTE-U). The access points 102 and 104 thus may be cellular base stations and the stations 106, 108, and 110 thus may be user equipment (UE) in accordance with some embodiments. In still other embodiments, the wireless network 100 is a WiMAX network or other type of wireless network.

Furthermore, in some embodiments the access points 102 and 104 may communicate with respective stations 106, 108, and/or 110 using multiple protocols. For example, respective access points and stations may communicate over a WLAN (e.g., using WiFi) while also exchanging cellular (e.g., LTE) messages. In another example, respective access points and stations may communicate over LTE-U while also exchanging cellular (e.g., LTE) messages.

In some embodiments, wireless communication in the wireless network 100 is performed using carrier-sense multiple access (CSMA). Before sending a transmission, a wireless device (e.g., an access point 102 or 104 or a station 106, 108, or 110) in the wireless network 100 monitors the wireless channel to determine whether the channel is busy or idle. If the channel (as sensed at the wireless device) is idle, the wireless device sends the transmission. If the channel is busy, however, the wireless device waits for a period of time (e.g., a random period of time) to expire before making another attempt to send the transmission. This waiting is referred to as backoff and is performed using a backoff counter. To determine whether the channel is busy or idle, the wireless device measures the channel power and determines whether the channel power satisfies (e.g., exceeds, or equals or exceeds) a carrier sense threshold. If the channel power satisfies the carrier sense threshold, the channel is busy. CSMA reduces the likelihood that packets will collide, thereby reducing packet loss.

The wireless network 100 may support the use of multiple modulation and coding schemes (MCSs). An MCS for a given transmission may be selected from a set of available MCSs. Each MCS specifies a modulation scheme and a code rate for forward error correction (FEC), and may also specify a number of spatial streams. Each MCS thus has a corresponding data rate, ranging from the lowest data rate for the most robust MCS to the highest data rate for the least robust MCS. In some embodiments, the most robust MCS (i.e., with the lowest data rate) uses binary phase-shift keying (BPSK) as its modulation scheme and successively less robust MCSs (i.e., with successively higher data rates) use increasing degrees of quadrature amplitude modulation (QAM) (e.g., up to 64-QAM, 128-QAM, or 256-QAM). In some embodiments, the code rates used by different MCSs in the set of available MCSs range between 1/2 and 5/6. A lower code rate corresponds to a higher degree of forward error correction (FEC) and thus to a lower data rate.

An MCS for a given transmission may be selected based at least in part on interference as measured at the receiving device. For example, the MCS may be selected based at least in part on channel power as measured at the receiving device. When the receiving device has multiple receive antennas, channel power may be measured separately on each receive antenna. The channel power measurements on all antennas are used jointly to determine the MCS selection. For a downlink transmission from an access point 102 or 104 to a station 106, 108, or 110, the MCS thus may be submitted based at least in part on interference at the station 106, 108, or 110. For an uplink transmission from a station 106, 108, or 110 to an access point 102 or 104, the MCS thus may be submitted based at least in part on interference at the access point 102 or 104.

In the following discussion, the wireless device that is to send the transmission is referred to as a first wireless device, while the wireless device that is to receive the transmission is referred to as a second wireless device.

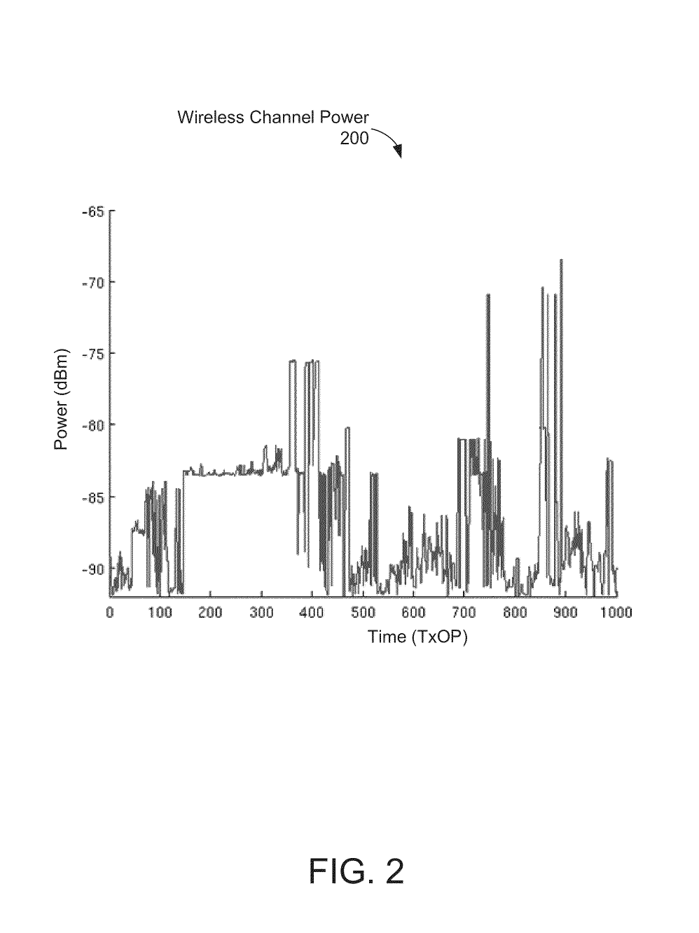

FIG. 2 is a graph showing wireless channel power 200 as measured at the second wireless device (e.g., a station 106, 108, or 110, or alternatively an access point 102 or 104) in accordance with some embodiments. The wireless channel power 200 shown in FIG. 2 is simulated and thus is a prophetic example of wireless channel power. If there are multiple receive antennas, it can be appreciated that there may be multiple sets of channel power measurements, one for each receive antenna. The wireless channel power 200 is measured over time in units of dBm (decibels referenced to one milliwatt). Time in FIG. 2 is measured in units of TxOP, which is a simulation variable. In one example, TxOP equals 3 milliseconds (ms). Measurement of the wireless channel power 200 is not additional overhead for the second wireless device, because the second wireless device already monitors the channel to detect packet preambles. The wireless channel power 200 is an example of wireless signal measurements made at the second wireless device. In some embodiments, the wireless signal measurements include phase measurements as well as channel power measurements. For example, if the second wireless device has multiple receive antennas, channel power and phase may be measured for each of the receive antennas.

Not all of the wireless channel power 200 (or, more generally, the wireless signals measured at the second wireless device) is interference that would impact the ability of the second wireless device to receive a transmission. The wireless channel power 200 includes power resulting from transmissions by the first wireless device itself. This component of the wireless channel power 200 of course will not interfere with transmissions from the first wireless device to the second wireless device. The wireless channel power 200 also includes power resulting from transmissions from other wireless devices that can be heard by both the first and second wireless devices, because both the first and second wireless devices are within range of the other wireless devices. This component of the wireless channel power 200 also will not interfere with transmissions from the first wireless device to the second wireless device, because of the use of CSMA in the wireless network 100. The first wireless device would not attempt to transmit while other wireless devices within range were transmitting, in accordance with CSMA.

Because some components of the wireless channel power 200 (or, more generally, the wireless signals measured at the second wireless device) would not affect a transmission from the first wireless device to the second wireless device, selection of an MCS based at least in part on the wireless channel power 200 would be too conservative, resulting in selection of an MCS that is unnecessarily robust and thus has an unnecessarily slow data rate. To avoid this problem, the times when the first wireless device either is transmitting or detects transmissions by other devices are recorded. That is, the times when the wireless channel is busy at the first wireless device are recorded. Wireless signal measurements made at the second wireless device at these times are then excluded from consideration when selecting an MCS for a transmission from the first wireless device to the second wireless device. For example, channel power as measured at the second wireless device at these times is excluded from consideration when selecting the MCS.

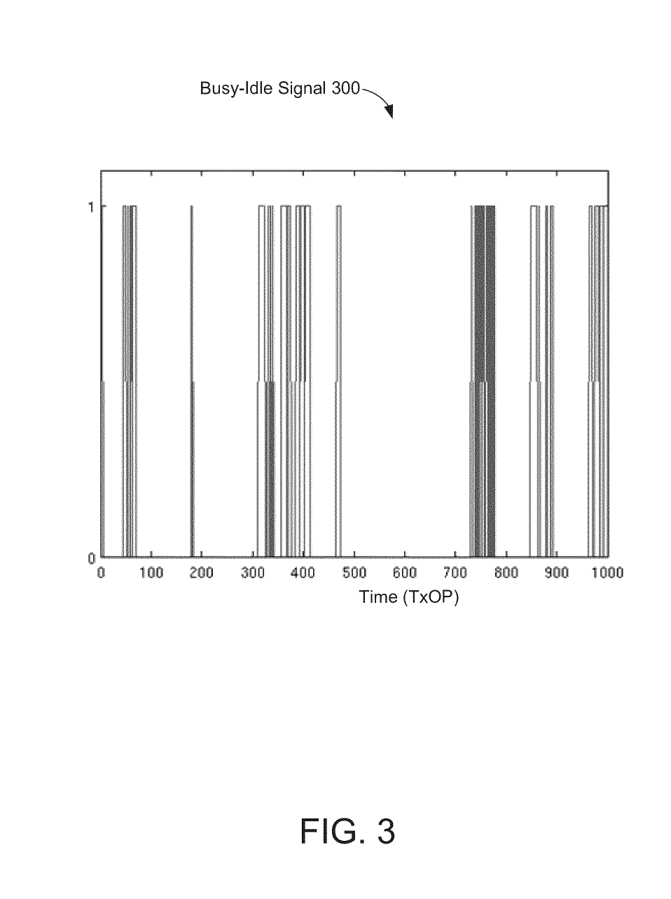

FIG. 3 is a graph of a busy-idle signal 300 as generated at the first wireless device in accordance with some embodiments. The first wireless device generates the busy-idle signal 300 by setting a bit to ‘1’ (and thus asserting the bit) when the wireless channel is busy at the first wireless device and by setting the bit to ‘0’ (and thus de-asserting the bit) when the wireless channel is idle at the first wireless device. (This convention may be reversed.) For example, the bit is asserted during measurement time intervals when the wireless channel is busy at the first wireless device and is de-asserted during measurement time intervals when the wireless channel is idle at the first wireless device. The first wireless device considers the wireless channel to be busy, and thus sets the bit to ‘1’, at times (e.g., during measurement time intervals) when the first wireless device is transmitting and at times (e.g., during measurement time intervals) when the first wireless device detects transmissions from other devices. The first wireless device considers the wireless channel to be idle, and thus sets the bit to ‘0’, at times when the first wireless device neither transmits nor detects transmissions. (The busy-idle signal 300 shown in FIG. 3 is the result of a simulation and therefore is a prophetic example of a busy-idle signal. The slight jog in the lines of FIG. 3 at 0.5 is an artifact of the graphing software used to plot the busy-idle signal 300; the busy-idle signal 300 is a binary signal that either equals 0 or 1 at any given time.)). Time in FIG. 3 is measured in units of TxOP, which is a simulation variable. In one example, TxOP equals 3 milliseconds (ms). In practice, any time unit can be used in accordance with the size of the measurement time interval.

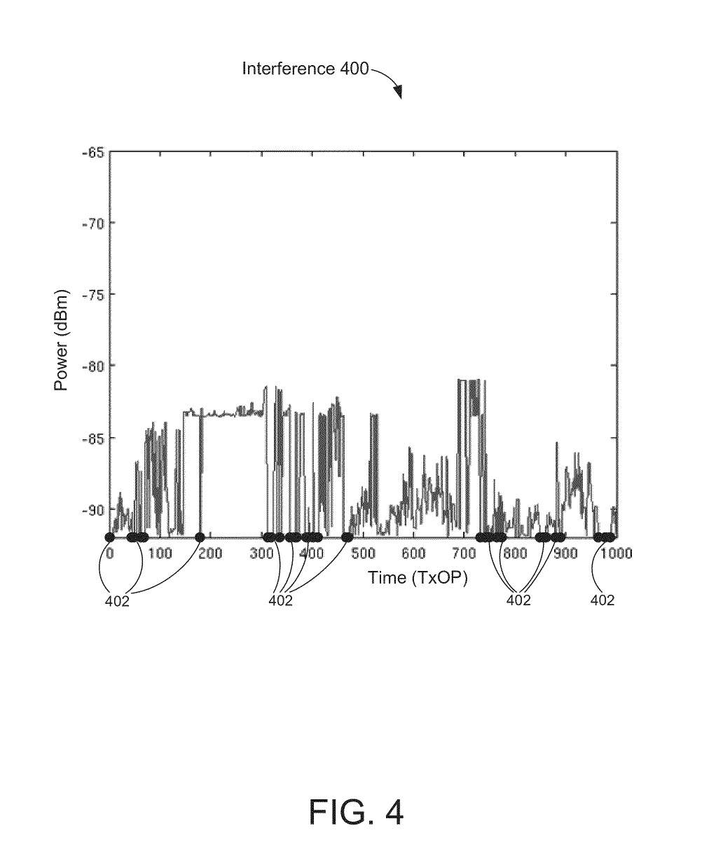

FIG. 4 is a graph of interference 400 as measured at the second wireless device in accordance with some embodiments. The interference 400 excludes wireless signal measurements made at the second wireless device at times 402 when the busy-idle signal 300 equals ‘1’. For example, the interference 400 is determined by excluding channel power measurements made at the times 402 from the wireless channel power 200 (FIG. 2).

The interference 400 includes interference from transmissions by devices that are hidden with respect to the first wireless device. Such devices, referred to as hidden nodes, are within range of the second wireless device but not the first wireless device. Since the first wireless device cannot hear a hidden node, it may transmit while the hidden node is transmitting, despite the use of CSMA. In one example, the station 108 is within range of the access point 102 but not the station 106. The station 108 is considered a hidden node with respect to the station 106, and transmissions from the station 108 may interfere with uplink transmissions from the station 106 to the access point 102. The interference 400 as measured at the access point 102 therefore would include interference resulting from transmissions by the station 108. (In this example, the station 106 is the first wireless device and the access point 102 is the second wireless device). In another example, the access point 104 is within range of the station 108 but not the access point 102. The access point 104 is considered a hidden node with respect to the access point 102, and transmissions from the access point 104 may interfere with downlink transmissions from the access point 102 to the station 108. The interference 400 as measured at the station 108 therefore would include interference resulting from transmission by the access point 104. (In this example, the access point 102 is the first wireless device and the station 108 is the second wireless device.) Still other examples are possible.

The busy-idle signal 300 is generated at the first wireless device, while wireless signal measurements (e.g., including the wireless channel power 200) are made at the second wireless device. The interference 400, however, may be determined at either the first wireless device or the second wireless device. For example, the first wireless device may transmit the busy-idle signal 300 to the second wireless device, which may determine the interference 400 based at least in part on the busy-idle signal 300 as received from the first wireless device and on wireless signal measurements (e.g., including the wireless channel power 200) as measured at the second wireless device. Alternatively, the second wireless device may transmit a signal specifying wireless signal measurements (e.g., including the wireless channel power 200) to the first wireless device, which may determine the interference 400 based at least in part on the wireless signal measurements as received from the second wireless device and the busy-idle signal 300 as generated at the first wireless device.

In some embodiments, to determine interference 400 at respective stations 106, 108, and/or 110, an access point 102 or 104 may broadcast its busy-idle signal 300 to all stations 106, 108, and/or 110 within range in a single transmission, thereby reducing network traffic overhead. Each station 106, 108, and/or 110 within range of the access point 102 or 104 then determines its own interference 400. Alternatively, each station 106, 108, and/or 110 within range of an access point 102 or 104 transmits a respective signal specifying its wireless channel power 200 to the access point 102 or 104, which then determines the interference 400 for each station 106, 108, and/or 110 within range.

In some embodiments, to determine interference 400 at an access point 102 or 104, a station 106, 108, or 110 may transmit its busy-idle signal 300 to the access point 102 or 104, which then determines its interference 400. Alternatively, the access point 102 or 104 transmits a signal specifying its wireless signal measurements (e.g., including the wireless channel power 200) to the station 106, 108, or 110, which then determines the interference 400 at the access point 102 or 104.

An MCS adaptation algorithm that selects an MCS based in part on the interference 400 is now presented. The algorithm selects an MCS from a set of available MCSs, which are indexed by an MCS index r. An MCS r is selected that optimizes a potential packet throughput potTP(r):

$$potTP ( r ) = rate ( r ) \times ( 1 - {P}_{Loss} ( r ) ) \times \frac{{T}_{payload}}{pktdur ( r ) + {W}_{ave} ( r ) + {T}_{OH}} \qquad ( 1 )$$

where rate(r) is the data rate of MCS r, P_{Loss}(r) is the probability of packet loss for MCS r, T_{payload}=L_{payload}/rate(r) is the time to transmit the MAC payload (with L_{payload} being the length/size of the MAC payload), pktdur(r) is the duration of a packet encoded using MCS r, Wₐᵥₑ(r) is an average delay in transmitting a packet due to backoff, and T_{OH} is transmission overhead that includes inter-frame spacing and time to transmit an acknowledgment message (ACK) acknowledging receipt of a packet.

The function rate(r) is a predefined function that maps each MCS index r to a respective data rate.

The function P_{Loss}(r) is defined as:

P_{Loss}(r)=(1−P_{Coll}(r))×(1−Pₑ) (2)

where P_{Coll} is a probability of packet collision and Pₑ is an error probability associated with P_{Coll}. The value of Pₑ may be predefined and is determined, for example, from statistics collected through simulation or actual operation of a wireless network 100 (FIG. 1). The function P_{Coll}(r) is defined as

$${P}_{Coll} ( r ) = \frac{potential collision}{potential TxOP} . \qquad ( 3 )$$

Potential TxOP is a duration of time during a specified time period that a wireless device could start a transmission. Potential TxOP may be determined from the busy-idle signal 300 (FIG. 3) by summing the times within a specified time period that the wireless device is idle. Potential collision is a duration of time during the specified time period for which, if the first wireless device had started a transmission, the packet being transmitted would have experienced a collision with another packet from another wireless device. Potential collision may be determined using the busy-idle signal 300, the interference 400 (FIG. 4), and a collision power threshold collPwrTh. The busy-idle signal 300 is used to identify times at which the wireless device could start a transmission, as described with respect to potential TxOP. The identified start times are followed by respective periods of duration pktdur(r) during which packets might be transmitted. If the interference 400 exceeds collPwrTh at any point during a respective period, then the hypothetical packet transmitted during the respective period would have experienced a collision, and the respective period counts toward potential collision.

In some embodiments, a channel quality index CQI(r) is predefined for each MCS r for a desired error probability Pₑ. The value of collPwrTh(r) to be used in evaluating equation 3 may then be determined using the relationship:

$$collPwrTh ( r ) = \frac{rxPwr}{CQI ( r )} \qquad ( 4 )$$

where rxPwr is the reception power level measured at the second wireless device, as determined for example based at least in part on a received signal strength indicator (RSSI). (Alternatively, a respective collision power threshold collPwrTh(r) may be predefined for each MCS r.) Interference with a power level lower than or equal to collPwrTh(r) is considered to be low-power interference I_{N}. A transmission that uses an MCS r has a probability 1−Pₑ of overcoming low-power interference I_{N}. Interference with a power level greater than collPwrTh(r) will cause collisions at the second wireless device, while low-power interference I_{N} can be tolerated (with a probability 1−Pₑ) through the use of the MCS r.

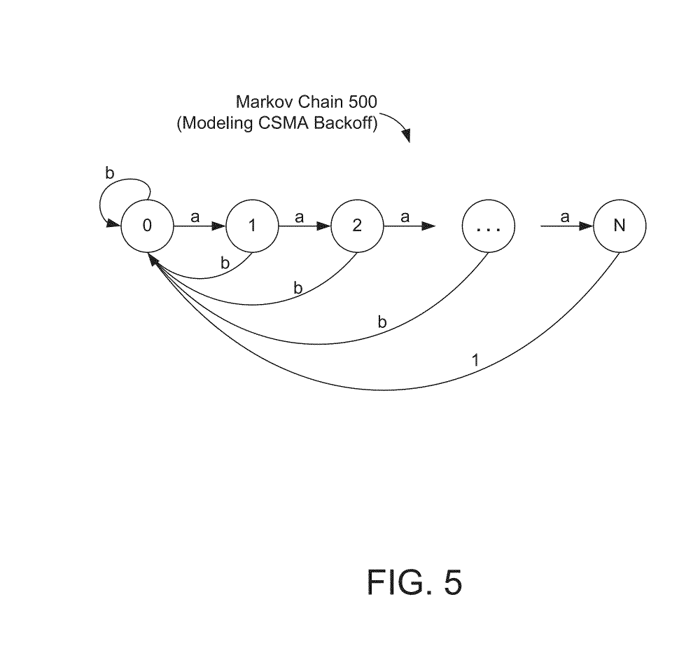

The average delay Wₐᵥₑ(r) may be determined by modeling backoff using a Markov chain 500, as shown in FIG. 5 in accordance with some embodiments. The Markov chain 500 has n states numbered 0 through N (i.e., nε[0, . . . , N]). The value n for each of the states corresponds to a number of packet retransmissions, where N is a maximum number of retransmissions. Successful packet transmission has a probability b of occurring, while unsuccessful packet transmission has a probability a of occurring. That is, a=P_{Loss} and b=1−P_{Loss}. Unsuccessful packet transmission results in subsequent retransmission, assuming n<N. A contention window size CW(n) is defined for each state n. In some embodiments, CW(n) is defined as:

CW(n)=min{(CWmin+1)×2ⁿ−1,CWmax} (5)

where CWmin is a minimum contention window size and CWmax is a maximum contention window size. A stationary distribution π for the Markov chain 500 is computed, in a well-known manner. Then

$${W}_{ave} = \frac{1}{2} {\sum }_{n = 0}^{N} π ( n ) CW ( n ) . \qquad ( 6 )$$

The formula for pktdur(r) is

$$pktdur ( r ) = \frac{{L}_{phy}}{rate ( {r}_{phy} )} + \frac{L}{rate ( r )} \qquad ( 7 )$$

where L is the size of the media access control (MAC) layer protocol data unit (PDU) for a packet, rate(r) is the data rate of MCS r, L_{phy} is physical layer (PHY) overhead for transmission of the packet, and rate(r_{phy}) is the data rate of an MCS r_{phy} used to modulate the PHY overhead. In some embodiments, the MCS r_{phy} is the most robust MCS available.

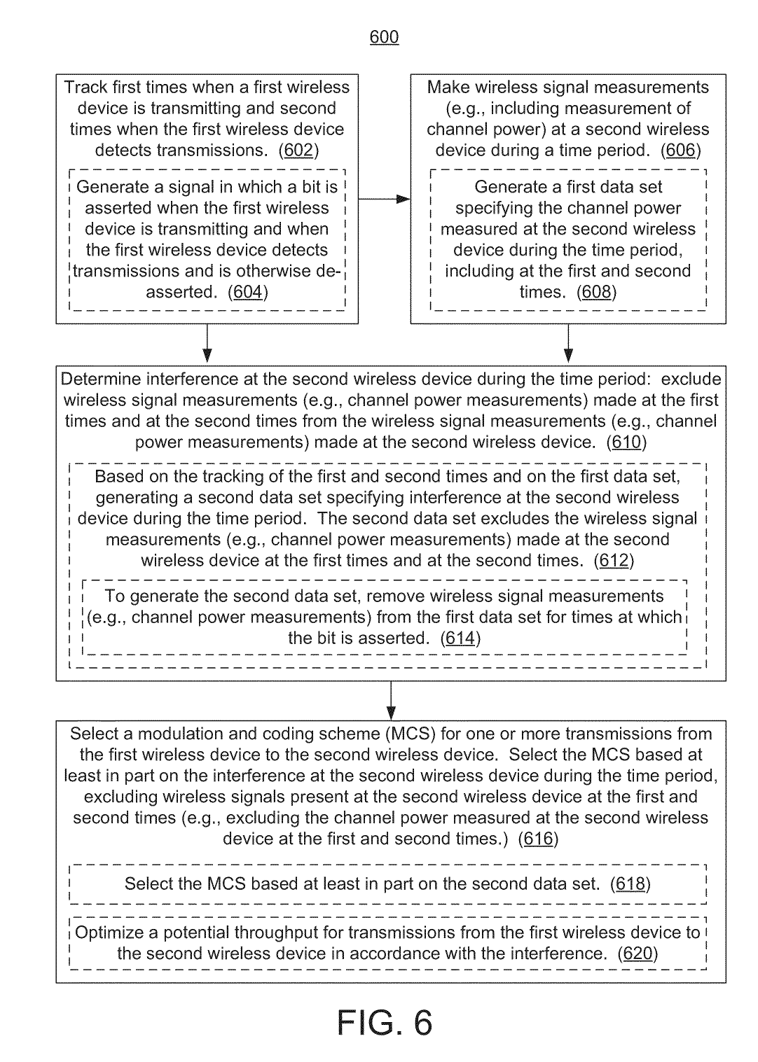

FIG. 6 is a flowchart showing a method 600 of performing MCS adaptation in accordance with some embodiments. The method 600 is used to select an MCS for one or more transmissions (e.g., packet transmissions) for a first wireless device (e.g., an access point 102 or 104, or alternatively a station 106, 108, or 110) to a second wireless device (e.g., a station 106, 108, or 110, or alternatively an access point 102 or 104). The method 600 is performed in a wireless network such as the wireless network 100 (FIG. 1).

First times when the first wireless device is transmitting and second times when the first wireless device detects transmissions are tracked (602). This tracking is performed at the first wireless device. For example, a signal (e.g., the busy-idle signal 300, FIG. 3) is generated (604) in which a bit is asserted when the first wireless device is transmitting and when the first wireless device detects transmissions and is otherwise de-asserted.

Wireless signal measurements are made (606) at a second wireless device during a time period. Making the wireless signal measurements may include measuring channel power (e.g., wireless channel power 200, FIG. 2) at the second wireless device during the time period. For example, a first data set is generated (608) that specifies the channel power measured at the second wireless device during the time period, including the channel power measured at the first and second times. The first data set thus may specify the wireless channel power 200 (FIG. 2), in accordance with some embodiments.

Interference (e.g., interference 400, FIG. 4) at the second wireless device during the time period is determined (610). To determine the interference, wireless signal measurements (e.g., channel power measurements) made at the first times and at the second times are excluded from the wireless signal measurements (e.g., channel power measurements) made at the second wireless device. Wireless signals present at the second wireless device at the first and second times are thus excluded from the interference. For example, a second data set is generated (612) that specifies interference at the second wireless device during the time period, based at least in part on the tracking of the first and second times in operation 602 and on the first data set generated in operation 608. The second data set excludes the wireless signal measurements (e.g., channel power measurements) made at the second wireless device at the first times and at the second times. In some embodiments, the second data set is generated by removing (614) wireless signal measurements (e.g., channel power measurements) from the first data set for times at which the bit in the signal of operation 604 (e.g., the busy-idle signal 300, FIG. 3) is asserted.

In some embodiments, the interference of operation 610 is determined at the second wireless device. For example, the second wireless device receives the busy-idle signal 300 from the first wireless device and determines the interference accordingly. Alternatively, the interference is determined at the first wireless device. For example, the first wireless device receives the first data set from the second wireless device and determines the interference accordingly.

An MCS is selected (616) for one or more transmissions (e.g., downlink transmissions, or alternatively uplink transmissions) from the first wireless device to the second wireless device. The MCS is selected based at least in part on the interference (e.g., the interference 400, FIG. 4) at the second wireless device during the time period, excluding the wireless signals present at the second wireless device at the first and second times (e.g., excluding the wireless signal measurements, such as the measured channel power, at the second wireless device at the first and second times). For example, the MCS is selected (618) based at least in part on the second data set. In some embodiments, an MCS is selected that optimizes (620) a potential throughput (e.g., as specified in Equation 1) for transmissions from the first wireless device to the second wireless device in accordance with the interference (e.g., by using the interference to evaluate Equation 3).

In some embodiments, the first wireless device selects the MCS (e.g., regardless of whether the determination of operation 610 was performed at the first wireless device or at the second wireless device). The first wireless device subsequently sends the one or more transmissions to the second wireless device using the selected MCS. Alternatively, the second wireless device selects the MCS and sends a signal to the first wireless device specifying the selected MCS. The first wireless device then sends the one or more transmissions to the second wireless device using the specified, selected MCS.

In some embodiments, all or a portion of the method 600 is performed in response to an indication of network traffic directed to the second wireless device. For example, an access point 102 or 104 transmits a traffic indication map (TIM) to a station 106, 108, or 110. The TIM indicates that the access point 102 or 104 has received network traffic to be forwarded to the station 106, 108, or 110. The station 106, 108, or 110 may be in a sleep mode (e.g., a low-power mode) when it receives the TIM. In response to the TIM, the station 106, 108, or 110 wakes from the sleep mode (e.g., transitions to an operating mode) and performs the operation 606 (e.g., including the operation 608). The station 106, 108, or 110 may also perform the operation 610 (e.g., including operations 612 and/or 614) and/or 616 (e.g., including operations 618 and/or 620) in response to the TIM.

Packet loss may prompt selection of a new MCS and/or a new value of another transmission parameter. Selection of a new value of a transmission parameter may also be referred to as adaptation of the transmission parameter. Whether adaptation of a transmission parameter decreases the likelihood of packet loss depends, however, on the cause of packet loss. Also, the proper choice of a transmission parameter to be adapted may depend on the cause of packet loss. For example, if packet loss results from poor channel conditions (e.g., from channel fading), then selecting a more robust MCS will decrease the likelihood of future packet loss. If packet loss results from packet collision, however, then selecting a more robust MCS will actually increase the likelihood of future packet loss, because the more robust MCS has a lower data rate that results in increased packet transmission time. When packet loss results from collision, it may be desirable to change another transmission parameter besides the MCS. For example, the backoff counter may be increased (e.g., doubled).

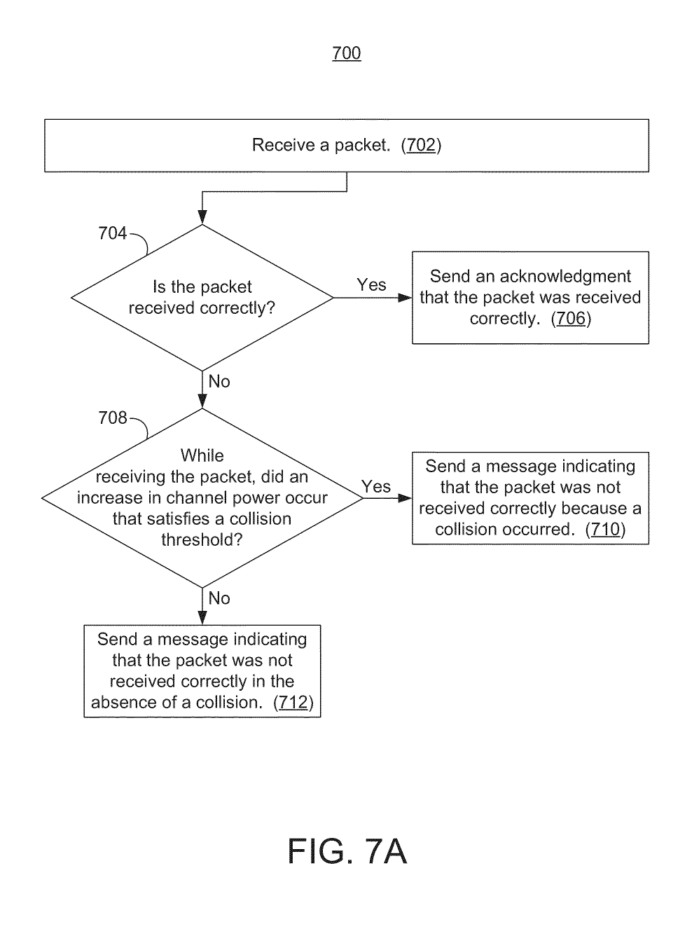

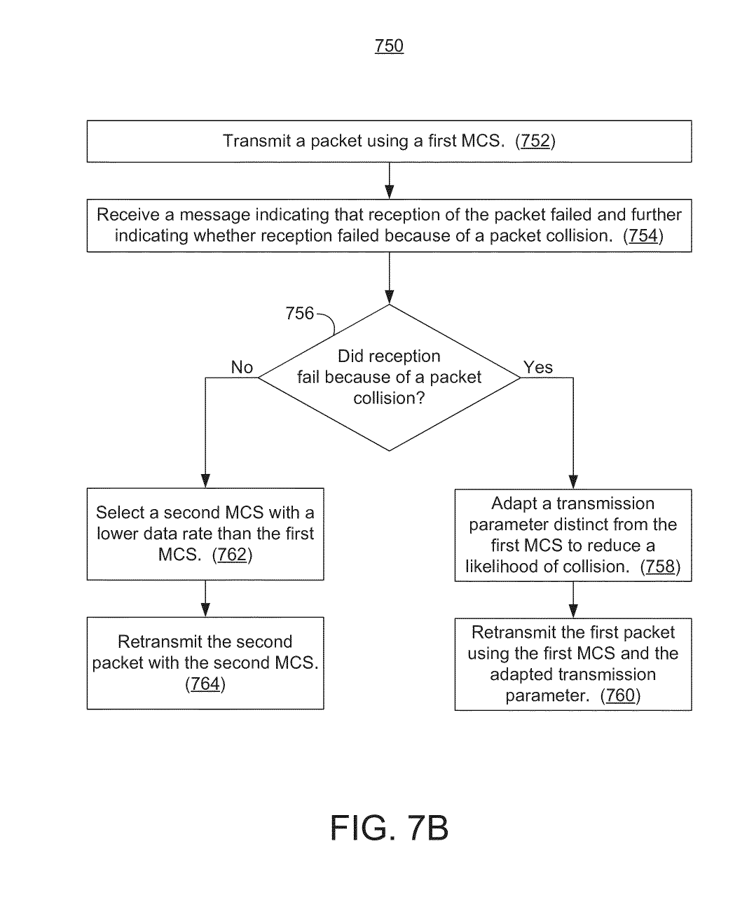

FIG. 7A is a flowchart showing a method 700 of determining whether packet loss results from packet collision in accordance with some embodiments. The method 700 is performed by a second wireless device (e.g., a station 106, 108, or 110, or alternatively an access point 102 or 104). The second wireless device receives (702) a packet from a first wireless device (e.g., from an access point 102 or 104, or alternatively from a station 106, 108, or 110). The second wireless device determines (704) whether the packet is received correctly. This determination is made, for example, based at least in part on a cyclic redundancy check (CRC). If the packet is received correctly (704—Yes), the second wireless device sends (706) an acknowledgment (ACK) that the packet was received correctly to the first wireless device.

If the packet was not received correctly (704—No), then it is determined (708) whether, while receiving the packet, an increase in channel power was detected that satisfies (e.g., exceeds, or equals or exceeds) a collision threshold. If such an increase was detected (708-Yes), then packet collision occurred. In response, the second wireless device sends (710) a message to the first wireless device indicating that the packet was not received correctly because a collision occurred. If no such increase was detected (708—No), then packet collision did not occur. The second wireless device sends (712) a message to the first wireless device indicating that the packet was not received correctly in the absence of a collision.

In some embodiments, the collision threshold of operation 708 is less than a capture threshold as used for the capture effect (e.g., in a WLAN). The capture effect is a physical-layer mechanism in which a receiver selects a packet to receive between multiple colliding packets. For example, if a receiver detects a packet preamble of a second packet while receiving a first packet, and if the power increase associated with arrival of the second packet is greater than the capture threshold, then the receiver will drop the first packet and switch to receiving the second packet. Otherwise the receiver will continue to receive the first packet.

FIG. 7B is a flowchart showing a method 750 of performing transmission parameter adaptation based at least in part on whether or not packet loss resulted from packet collision in accordance with some embodiments. The method 750 is performed by a first wireless device (e.g., an access point 102 or 104, or alternatively a station 106, 108, or 110). The first wireless device transmits (752) a packet using a first MCS. In some embodiments, this packet is the packet received by a second wireless device in operation 702 of the method 700 (FIG. 7A). The first wireless device subsequently receives (754) a message (e.g., the message sent in operation 710 or 712 of the method 700, FIG. 7A) indicating that reception of the packet failed and further indicating whether reception failed because of a packet collision.

If reception did not fail because of a packet collision (756—No), then a second MCS with a lower data rate than the first MCS is selected (762). The second MCS is thus more robust than the first MCS. The second packet is retransmitted (764) using the second MCS. Alternatively, or in addition, one or more subsequent packets are transmitted using the second MCS.

If reception failed because of a packet collision (756—Yes), then a transmission parameter distinct from the first MCS is adapted (758) to reduce a likelihood of collision. For example, a backoff counter is increased (e.g., doubled). The first packet is retransmitted (760) using the first MCS and the adapted transmission parameter. Alternatively, or in addition, one or more subsequent packets are transmitted using the first MCS and the adapted transmission parameter.

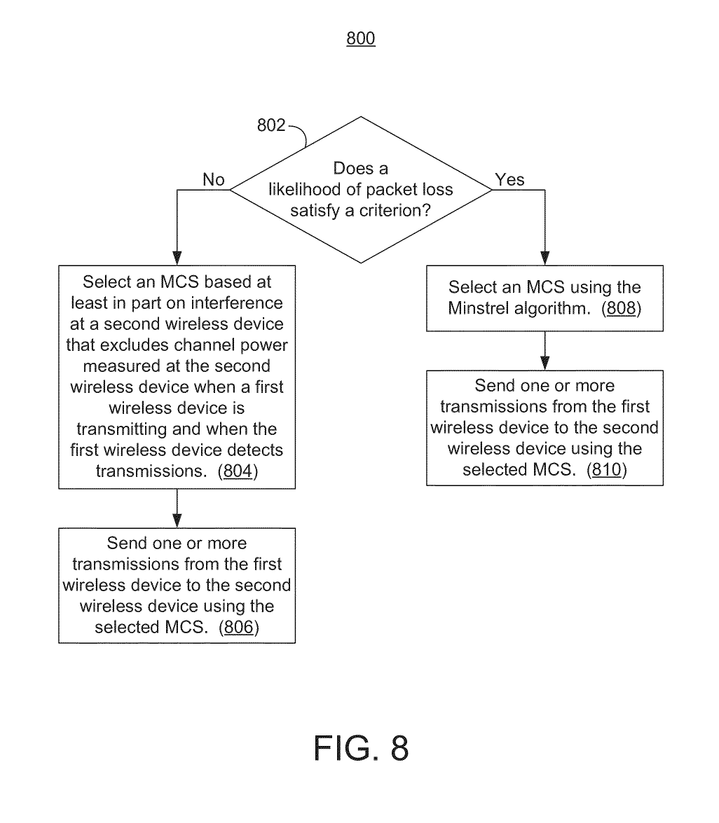

In some embodiments, a wireless device may select between multiple MCS adaptation algorithms, based for example on an amount of network traffic or a related criterion. FIG. 8 is a flowchart showing a method 800 in which MCS adaptation is performed using one of two available MCS adaptation algorithms in accordance with some embodiments. In the method 800, a determination is made (802) as to whether a likelihood of packet loss satisfies (e.g., is greater than, or greater than or equal to) a criterion (e.g., a predefined threshold). The likelihood of packet loss is related to network traffic, because the likelihood of packet loss increases as the amount of network traffic increases.

If the likelihood of packet loss does not satisfy the criterion (802—No), an MCS is selected (804) based at least in part on interference at a second wireless device that excludes channel power measured at the second wireless device when a first wireless device is transmitting and when the first wireless device detects transmissions. For example, an MCS is selected as described for operation 616 (e.g., including operations 618 and/or 620) of the method 600 (FIG. 6), in accordance with Equation 1. The first wireless device sends (806) one or more transmissions to the second wireless device using the selected MCS.

If the likelihood of packet loss satisfies the criterion (802-Yes), an MCS is selected (808) using the well-known Minstrel algorithm. The first wireless device sends (810) one or more transmissions to the second wireless device using the selected MCS.

While the methods 600 (FIG. 6), 700 (FIG. 7A), 750 (FIG. 7B), and 800 (FIG. 8) include a number of operations that appear to occur in a specific order, it should be apparent that the methods 600, 700, 750, and/or 800 can include more or fewer operations. An order of two or more operations may overlap and two or more operations may be combined into a single operation.

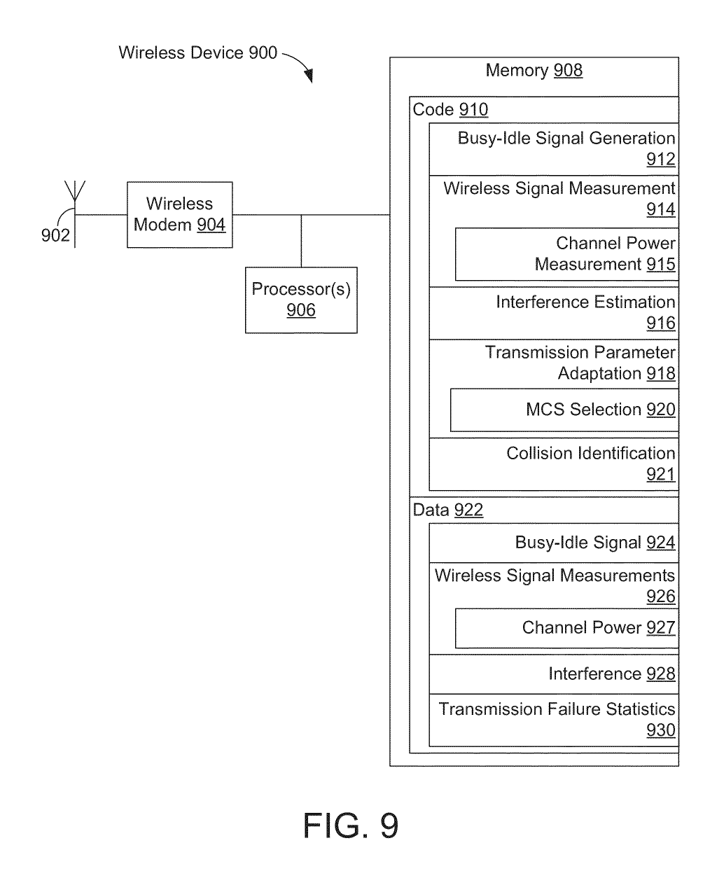

FIG. 9 is a block diagram of a wireless device 900 in accordance with some embodiments. The wireless device 900 may be an example of an access point 102 or 104 or a station 106, 108, or 110 (FIG. 1). The wireless device 900 includes one or more antennas 902 coupled to a wireless modem 904 that transmits and receives signals through the one or more antennas 902. In some embodiments, the one or more antennas 902 include multiple transmit and/or receive antennas. For example, the wireless device 900 may be a MIMO device. The wireless device 900 also includes memory 908 and one or more processors 906. The memory 908 stores code 910 configured for execution by the one or more processors 906. The code 910 may be stored in a non-transitory computer-readable storage medium (e.g., non-volatile memory) in the memory 908. The memory 908 also stores data 922 to be referenced by the one or more processors 906 when executing the code 910.

The code 910 includes various program modules, each of which includes instructions configured for execution by the one or more processors 906. The program modules may include a busy-idle signal generation module 912, a wireless signal measurement module 914 (e.g., including a channel power measurement module 915), an interference estimation module 916, a transmission parameter adaptation module 918, and a collision identification module 921. The busy-idle signal generation module 912 includes instructions for generating the busy-idle signal 300 (e.g., in accordance with operations 602 and 604, FIG. 6). The channel power measurement module 914 includes instructions for measuring the wireless channel power 200 (FIG. 2) (e.g., in accordance with operations 606 and 608, FIG. 6). The interference estimation module 916 includes instructions for determining the interference 400 (FIG. 4) (e.g., in accordance with operations 610, 612, and 614, FIG. 6). The collision identification module 921 includes instructions for performing the method 700 (FIG. 7A). The transmission parameter adaptation module 918 includes an MCS selection module 920 with instructions for selecting an MCS in accordance with operations 616, 618, and 620 (FIG. 6); these instructions may include instructions for evaluation equations 1-7 or a portion thereof. The transmission parameter adaptation module 918 may also include instructions for performing the methods 750 (FIG. 7B) and/or 800 (FIG. 8). In some embodiments, the MCS selection module 920 further includes instructions for selecting an MCS using a second algorithm (e.g., the Minstrel algorithm, in accordance with operation 808, FIG. 8).

Accordingly, the code 910 may include instructions for performing all or a portion of the methods 600 (FIG. 6), 700 (FIG. 7A), 750 (FIG. 7B), and/or 800 (FIG. 8).

The data 922 may include busy-idle signal data 924 (e.g., for the busy-idle signal 300, FIG. 3), wireless signal measurement data 926, and interference data 928 (e.g., for the interference 400, FIG. 4). The wireless signal measurement data 926 may include channel power data 927 (e.g., for the wireless channel power 200, FIG. 2). The data 922 may further include statistics 930 regarding transmission failures. The statistics 930 may be used to adapt one or more transmission parameters. In some embodiments, the statistics 930 are updated when a message (e.g., the message of operation 712, FIG. 7A) is received indicating that a packet was not received correctly in the absence of a packet collision but not when a message (e.g., the message of operation 710, FIG. 7A) is received indicating that a packet was not received correctly because of a collision.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of facilitating wireless communication, comprising:
at a respective wireless device that is one of a first wireless device and a second wireless device, selecting a modulation and coding scheme (MCS) for one or more transmissions from the first wireless device to the second wireless device,
wherein the MCS is selected based at least in part on interference at the second wireless device during a time period, the interference excluding wireless signals present at the second wireless device at first times during the time period when the first wireless device is transmitting and at second times during the time period when the first wireless device detects transmissions.

2. The method of claim 1, wherein the respective wireless device is the first wireless device, the method further comprising, at the first wireless device:
tracking the first times and the second times;
receiving from the second wireless device a first data set specifying wireless signal measurements made at the second wireless device during the time period, the first data set including measurements of the wireless signals present at the second wireless device at the first times and at the second times; and
based at least in part on the tracking and the first data set, generating a second data set specifying interference at the second wireless device during the time period, the second data set excluding the measurements of the wireless signals present at the second wireless device at the first times and at the second times;
wherein selecting the MCS comprises selecting the MCS based at least in part on the second data set.

3. The method of claim 2, wherein:
tracking the first times and the second times comprises generating a signal in which a bit is asserted when the first wireless device is transmitting and when the first wireless device detects transmissions and is otherwise de-asserted; and
generating the second data set comprises removing from the first data set wireless signal measurements made at the second wireless device at times when the bit is asserted.

4. The method of claim 2, wherein:
the first wireless device comprises an access point in a wireless local area network (WLAN);
the second wireless device comprises a station in the WLAN; and
selecting the MCS comprises selecting an MCS for one or more downlink transmissions from the access point to the station.

5. The method of claim 2, wherein:
the first wireless device comprises a base station in a Long-Term Evolution Advanced network in unlicensed spectrum (LTE-U);
the second wireless device comprises a user equipment (UE) in the LTE-U; and
selecting the MCS comprises selecting an MCS for one or more downlink transmissions from the base station to the UE, the one or more downlink transmissions being LTE-U transmissions.

6. The method of claim 4, further comprising sending from the access point to the station an indication that network traffic directed to the station is present at the access point;
wherein the access point receives the first data set from the station in response to sending the indication.

7. The method of claim 1, wherein the respective wireless device is the second wireless device, the method further comprising, at the second wireless device:
making wireless signal measurements during the time period;
receiving from the first wireless device a signal specifying the first times and the second times; and
determining the interference at the second wireless device during the time period, the determining comprising excluding wireless signal measurements made at the first times and at the second times from the wireless signal measurements made during the time period.

8. The method of claim 7, further comprising, at the second wireless device:
sending a signal specifying the MCS to the first wireless device; and
receiving a transmission from the first wireless device using the MCS.

9. The method of claim 7, wherein:
the first wireless device comprises a station in a WLAN;
the second wireless device comprises an access point in the WLAN; and
selecting the MCS comprises selecting an MCS for one or more uplink transmissions from the station to the access point.

10. The method of claim 1, wherein selecting the MCS comprises optimizing a potential throughput for transmissions from the first wireless device to the second wireless device in accordance with the interference.

11. The method of claim 10, wherein optimizing the potential throughput comprises calculating a collision probability based in part on the interference.

12. The method of claim 1, wherein the MCS is selected from a set of available MCSs, each of which corresponds to a distinct combination of modulation scheme, code rate, and number of spatial streams.

13. The method of claim 1, further comprising, at the second wireless device:
while receiving a packet using the MCS, identifying an increase in channel power that satisfies a collision threshold;
determining that the packet is not received correctly; and
in response to the identifying and the determining, transmitting a message to the first wireless device indicating that the packet was not received correctly because a collision occurred;
wherein the collision threshold is less than a capture threshold for determining whether to switch from receiving a first packet to receiving a second packet without completing reception of the first packet.

14. The method of claim 1, wherein the MCS is a first MCS, the method further comprising, at the first wireless device:
transmitting a first packet to the second wireless device using the first MCS;
receiving a first message from the second wireless device indicating that a packet collision resulted in failed reception of the first packet;
in response to the first message, adapting a transmission parameter distinct from the first MCS to reduce a likelihood of collision and retransmitting the first packet using the first MCS and the adapted transmission parameter;
transmitting a second packet to the second wireless device using the first MCS;
receiving a second message from the second wireless device indicating that reception of the second packet failed in the absence of a packet collision; and
in response to the second message, selecting a second MCS with a lower data rate than the first MCS and retransmitting the second packet with the second MCS.

15. The method of claim 1, wherein:
selecting the MCS comprises selecting the MCS for a first set of one or more transmissions, based at least in part on the interference, in response to a determination that a likelihood of packet loss satisfies a criterion; and
the method further comprises using a Minstrel algorithm to select an MCS for a second set of one or more transmissions, in response to a determination that a likelihood of packet loss does not satisfy the criterion.

16. A wireless device, comprising:
one or more antennas;
a wireless modem to transmit and receive transmissions through the one or more antennas;
one or more processors; and
memory storing one or more programs configured for execution by the one or more processors, the one or more programs comprising:
instructions to select a modulation and coding scheme (MCS) for one or more transmissions from a first wireless device to a second wireless device, the instructions comprising instructions to select the MCS based at least in part on interference at the second wireless device during a time period, the interference excluding wireless signals present at the second wireless device at first times during the time period when the first wireless device is transmitting and at second times during the time period when the first wireless device detects transmissions.

17. The wireless device of claim 16, wherein the wireless device is the first wireless device, the one or more programs further comprising:
instructions to track the first times and the second times; and
instructions to generate a second data set specifying the interference at the second wireless device during the time period, the instructions to generate the second data set comprising instructions to exclude measurements of the wireless signals present at the second wireless device at the first times and at the second times from a first data set received from the second wireless device that specifies measurements of wireless signals present at the second wireless device during the time period, the first data set including the wireless signals present at the second wireless device at the first times and at the second times;
wherein the instructions to select the MCS comprise instructions to select the MCS based at least in part on the second data set.

18. The wireless device of claim 16, wherein the wireless device is the second wireless device, the one or more programs further comprising:
instructions to make wireless signal measurements during the time period; and
instructions to determine the interference at the second wireless device during the time period, the instructions to determine the interference comprising instructions to exclude wireless signal measurements made at the first times and at the second times from the wireless signal measurements made during the time period, based at least in part on a signal received from the first wireless device specifying the first times and the second times.

19. A non-transitory computer-readable storage medium storing one or more programs configured for execution by one or more processors, the one or more programs comprising:
instructions to select a modulation and coding scheme (MCS) for one or more transmissions from a first wireless device to a second wireless device, the instructions comprising instructions to select the MCS based at least in part on interference at the second wireless device during a time period, the interference excluding wireless signals present at the second wireless device at first times during the time period when the first wireless device is transmitting and at second times during the time period when the first wireless device detects transmissions.

20. The computer-readable storage medium of claim 19, wherein the one or more processors are situated in the first wireless device, the one or more programs further comprising:
instructions to track the first times and the second times; and
instructions to generate a second data set specifying the interference at the second wireless device during the time period, the instructions to generate the second data set comprising instructions to exclude measurements of wireless signals present at the second wireless device at the first times and at the second times from a first data set received from the second wireless device that specifies wireless signals received at the second wireless device during the time period, the first data set including the wireless signals received at the second wireless device at the first times and at the second times;
wherein the instructions to select the MCS comprise instructions to select the MCS based at least in part on the second data set.
